(19) United States
(12) Patent Application Publication
(10) Pub. No.: US 2006/0044650 A1
(43) Pub. Date: Mar. 2, 2006

(54) Low insertion loss circulator

(76) Inventors: Liren Du, Santa Clara, CA (US); Qi Deng, Cupertino, CA (US); Kevin Zhang, Fremont, CA (US); Tengda Du, Fremont, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/196,572

(22) Filed: Aug. 2, 2005

Related U.S. Application Data
(60) Provisional application No. 60/605,186, filed on Aug. 27, 2004.

(51) Int. Cl. G02B 27/28

(52) U.S. Cl. 359/495; 359/483

(57) ABSTRACT

This disclosure concerns low insertion loss optical circulators. In one example, the optical circulator has four ports and includes a polarization dividing and combining element that is positioned adjacent the first and fourth ports and is adapted to divide a beam of light into two beams of light of orthogonal polarizations. The polarization dividing and combining element is also adapted to combine two beams of light of orthogonal polarizations into one beam of light. The optical circulator also includes a Faraday rotator positioned near the second port, and a Faraday rotator positioned near the third port. The Faraday rotator rotates beams of light before or after the pass through the polarization dividing and combining elements.

### CROSS-REFERENCE TO RELATED APPLICATIONS

This application claims priority to U.S. Provisional Patent Application Ser. No. 60/605,186, entitled “Low Insertion Loss Circulator” filed Aug. 27, 2004, which is hereby incorporated herein by reference in its entirety.

### BACKGROUND OF THE INVENTION

1. The Field of the Invention

In general, embodiments of the present invention relate to components used in fiber optic networks. More particularly, embodiments of the present invention relate to optical circulators.

2. Related Technology

Fiber optic technology is frequently employed in computer and computer networking applications. Fiber optic lines or cables are often used to interconnect computers and computer networks. Generally speaking, computer networks configured using fiber optic cables offer improved bandwidth over conventional electronic networks. Therefore, development of technologies involving the use of fiber optic cables is increasing.

As the use of fiber optic networks increases, the need for more effective utilization of fiber optic networks also increases. One way of accomplishing more effective fiber optic network use is through the application of wavelength division multiplexing (“WDM”) technology. In systems employing WDM technology, a number of different signals of different wavelengths can be carried on a single fiber. Each wavelength is capable of carrying its own independent signal at full speed. Therefore, the system is able to handle a number of different services simultaneously while at the same time maintaining a high transmission speed.

An optical circulator is a key component used in WDM optical add/drop modules. The optical circulator functions to extract and/or multiplex desired wavelengths of the optical signal being transmitted through the fiber optic lines. More particularly, optical circulators redirect light from one port to another port while minimizing back reflection and back scattering in the reverse directions for any state of polarization. In addition to being useful in WDM networks, optical circulators are widely used in bidirectional transmission, fiber amplifier systems, and in optical time domain reflectometer (OTDR) measurements.

Although optical circulators are widely used in a number of different applications, conventional optical circulators are typically made using a substantial number of optical components, such as a multiplicity of birefringent crystals. Because birefringent crystals must be large enough to provide an adequate optical path length to realize the function of the optical circulator, such optical circulators have substantial insertion loss, or loss of optical power due to the insertion of the circulator into the network path.

Similarly, in other optical applications, insertion loss caused by optical circulators is problematic. Often, such insertion loss can reach unacceptably high levels where the optical application is unable to function due to the optical power lost in the optical circulator. Therefore, optical circulators with low insertion loss are desirable to increase efficiency in fiber optic network and other applications.

In addition to being sensitive to insertion loss created by the use of optical circulators, many applications only have a limited amount of physical space available for the optical circulator. Typical optical circulators configured, for example, with multiple crystals may exceed physical design constraints for a given application. Therefore, optical circulators configured using fewer components and characterized by low insertion loss would be desirable.

### BRIEF SUMMARY OF AN EXEMPLARY EMBODIMENT OF THE INVENTION

The above noted and other difficulties and problems associated with the use of optical circulators are overcome by embodiments of the present invention in which a small-scale optical circulator is highly integrated while offering capabilities of conventional larger modules. The integrated optical circulator of one embodiment of the invention provides a relatively low insertion loss, has relatively fewer components than some optical circulators, a relatively compact size, and is relatively less expensive to manufacture.

These and other aspects of embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings are not drawn to scale. The invention will be described and explained with additional specificity and detail through the use of the accompanying drawings in which:

FIG. 1 illustrates an exemplary embodiment of a low insertion loss circulator with a polarization beam splitter;

FIG. 2 shows the transmission path of an optical signal transmitted through an exemplary low insertion loss circulator having a polarization beam splitter;

FIG. 3 shows the reception path of an optical signal received into an exemplary low insertion loss circulator having a polarization beam splitter;

FIG. 4A shows the transmission path of an optical signal transmitted through an exemplary low insertion loss circulator having multiple beam displacers; and

FIG. 4B shows the reception path of optical signals received into an exemplary low insertion loss circulator having multiple beam displacers.

### DETAILED DESCRIPTION OF EXEMPLARY EMBODIMENTS OF THE INVENTION

Embodiments of the present invention concern optical circulators, which may also be referred to herein simply as “circulators,” configured with relatively few optical components of integrated functionality that provide low insertion loss when used in connection with other optoelectronic components and/or systems. In one exemplary embodiment of the invention, the circulator includes four ports, a polarization beam splitter, and two Faraday rotators. The ports, polarization beam splitter, and Faraday rotators are configured such that optical signals can be transmitted from, or received by, one or more ports of the circulator. The optical signal is rotated and deflected within the circulator such that the optical signal travels to a port of the circulator different from the one or more ports of the circulator by way of which the optical signal was initially transmitted or received. The relatively limited number of optical components, integrated functionality of the components, and relatively short optical path length of the circulator provide for a compact, low insertion loss optical device.

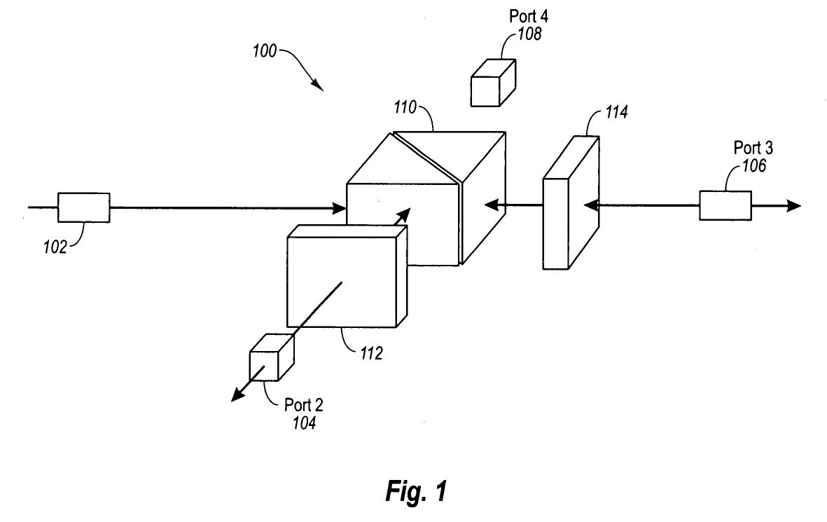

With attention now to FIG. 1, an exemplary circulator 100 is shown. Circulator 100 includes ports 102, 104, 106, and 108, and a polarization dividing and combining element 110. Light received or transmitted through any of ports 102, 104, 106, and 108 passes through polarization dividing and combining element (“PDCE”) 110. In one exemplary embodiment of the invention, PDCE 110 is a polarization beam splitter (“PBS”). PDCE 110 may be of any conventional type and may be configured in one of several different ways. For example, the PDCE 110 may be configured using Wollaston, Nicol, Rochon, Glen-Thompson, or Glen-Taylor prisms. Additionally, the PDCE 110 may be configured using thin-film coatings on right angle prisms, or PDCE 110 may comprise a birefringent crystal. In one embodiment of the invention, PDCE 110 comprises a high-quality birefringence material characterized by a relatively high polarization extinction ratio, and yielding a relatively low combining loss and relatively high power. PDCE 110 may be configured of any number of birefringent materials, such as, for example, calcite, YVO4, Rutile, LiNbO₃, or any other single birefringent crystalline material.

In addition to PDCE 110, circulator 100 also includes Faraday rotators 112 and 114 arranged for optical communication with ports 104 and 106, respectively. The exemplary Faraday rotators 112 and 114 produce a uniform 45 degree polarization rotation on an optical signal which passes through Faraday rotators 112 or 114.

In one embodiment of the invention, Faraday rotators 112 and 114 are comprised of glass. In another embodiment of the invention, Faraday rotators 112 and 114 utilize high strength magnets in conjunction with a high damage threshold optical element to produce a uniform polarization rotation.

The Faraday rotators 112 and 114 may also be configured of magneto-optical material, such as, for example, a rare-earth iron garnet. In addition, Faraday rotators 112 and 114 may be latching or non-latching. Further, depending on the composition of the Faraday rotators 112 and 114, magnets may or may not be used to apply a magnetic field to the Faraday rotators 112 and 114. While exemplary Faraday rotators 112 and 114 shown in FIG. 1 each impose a rotation angle of 45 degrees, Faraday rotators configured to impose other rotation angles may be used in other embodiments of the invention.

In operation, circulator 100 is able to both transmit and receive optical signals. In one embodiment of the invention, an optical signal enters circulator 100 at port 102 and is transmitted from port 102 through PDCE 110. In the exemplary embodiment shown in FIG. 1, light of a first polarization is transmitted without deviation through PDCE 110. Light of a second polarization, orthogonal to the first polarization, is deviated by 90 degrees. The light of the first polarization transmitted without deviation through PDCE 110 passes through Faraday rotator 114 and subsequently exits circulator 100 through port 106. The light of the second polarization, which is deviated by 90 degrees within circulator 100, passes through Faraday rotator 112 and subsequently exits circulator 100 through port 104. In the embodiment shown in FIG. 1, no light exits circulator 100 through port 108.

As shown in FIG. 1, circulator 100 provides a relatively compact circulator comprised of relatively few optical components. The number of components, and relatively short optical path length that characterize the circulator 100 shown in FIG. 1 thus introduce relatively low insertion loss when the circulator 100 is connected with other optoelectronic components.

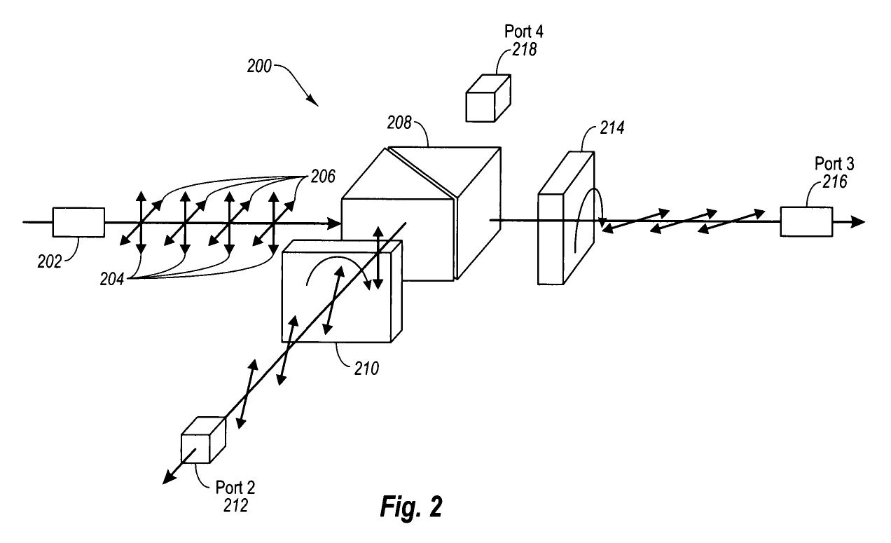

With attention now to FIG. 2, the transmission path of an optical signal transmitted through circulator 200 is shown. When the light enters circulator 200 through port 202, the light may be polarized or unpolarized, or the light may have any combination of polarization states. In the exemplary embodiment shown in FIG. 2, light entering circulator 200 through port 202 is unpolarized. The light entering port 202 can be decomposed into orthogonally polarized light, where one component is horizontally polarized light or P polarization, represented by vectors 204, and the other component is vertically polarized light or S polarization, represented by vectors 206. When the S ray passes through a PDCE, implemented in this example as PBS 208, the S ray is deviated by 90 degrees. The S ray exits PBS 208 and passes through Faraday rotator 210, where the polarization angle of the S ray is rotated by 45 degrees. The S ray then exits circulator 200 through port 212.

The P ray, represented by vectors 206, passes through PBS 208 with no deviation. The P ray then passes through Faraday rotator 214 where the polarization angle of the P ray is rotated by 45 degrees, and the P ray then exits circulator 200 through port 216. In the exemplary embodiment shown in FIG. 2, no component of the light entering circulator 200 through port 202 exits the circulator through port 218.

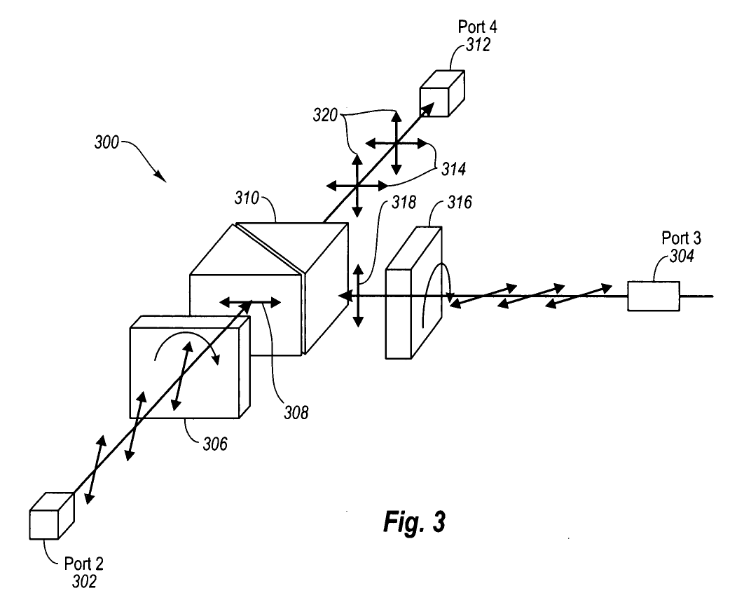

As noted elsewhere herein, exemplary circulators not only transmit but also receive optical signals. Directing attention now to FIG. 3, details are provided concerning the reception path of light which enters a circulator 300 through ports 302 and 304. In particular, polarized light may enter circulator 300 at port 304. In the exemplary embodiment of the invention shown in FIG. 3, the light entering circulator 300 at port 304 has the same polarization state as light exiting corresponding port 216 in FIG. 2. However, in other exemplary embodiments of the invention the light entering port 304, or another port of circulator 300, may have another polarization state.

After entering circulator 300 at port 304, the light passes through Faraday rotator 316. By passing through Faraday rotator 316, the polarization angle of the light is rotated by 45 degrees. Such a rotation changes the light such that the polarization state of the light is orthogonal to the polarization state of the light entering Faraday rotator 214, shown in FIG. 2. The polarization state of the light exiting Faraday rotator 316 is shown by vector 318.

After being rotated 45 degrees by Faraday rotator 316, the light passes through PBS 310. PBS 310 deviates the light, which is then directed toward port 312. The polarization state of the light which exits the circulator 300 at port 312, after having initially entered circulator 300 at port 304, is shown by vectors 320.

Not only can light enter circulator 300 at port 304, polarized light may also enter circulator 300 at port 302. In the exemplary embodiment shown in FIG. 3, light entering circulator 300 at port 302 has a polarization state identical to the polarization state of the light exiting port 212, shown in FIG. 2. In other embodiments of the invention, however, light entering circulator 300 through port 302 may have another polarization state.

After entering circulator 300 at port 302, the light passes through Faraday rotator 306, which rotates the polarization angle of the light by 45 degrees. Thus, upon exiting Faraday rotator 306, the light has a polarization state orthogonal to the polarization state of the light entering Faraday rotator 210, as shown in FIG. 2. The polarization state of the light that entered circulator 300 through port 302 and traveled through Faraday rotator 306 is shown by vector 308. Consequently, the beam is not deviated by PBS 310, but passes through the PBS 310 undeviated and exits the circulator 300 by way of port 312. The polarization state of the light which exits circulator 300 at port 312, after having initially entered circulator 300 at port 302, is shown by vectors 314.

As is shown in FIG. 3, light enters circulator 300 from either of ports 302 or 304, and ultimately exits circulator 300 through port 312. Circulator 300 enables light received into ports 302 and 304 to be routed through PBS 310 and ultimately to exit circulator 300 through port 312, while using relatively few optical components and relatively short optical paths for the light transmitted throughout the circulator 300. Thus, circulator 300 is a low insertion loss circulator which can be implemented with any number of different optoelectronic components in any number of different configurations.

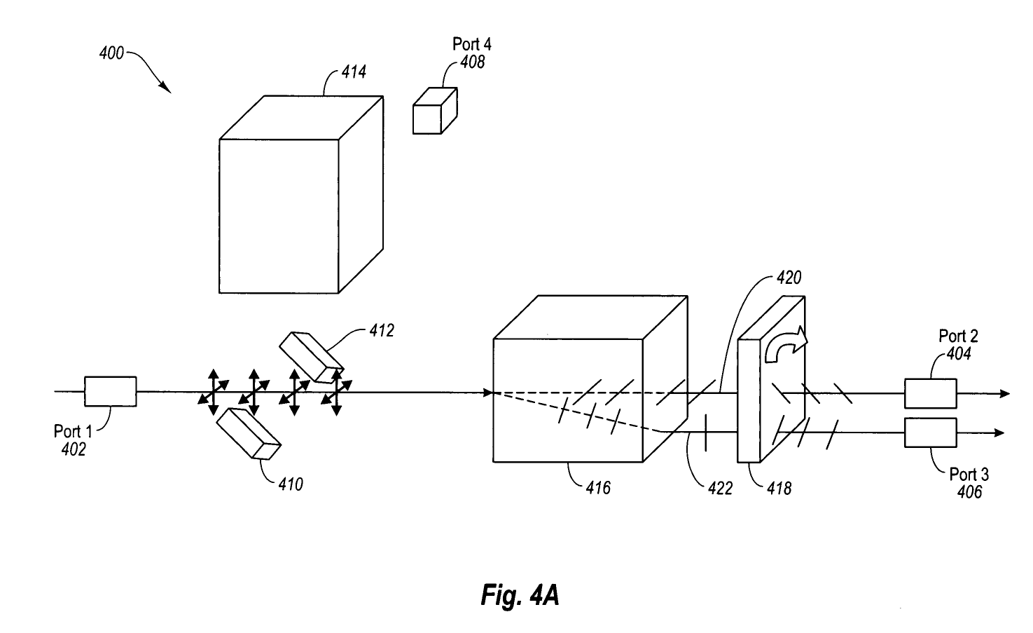

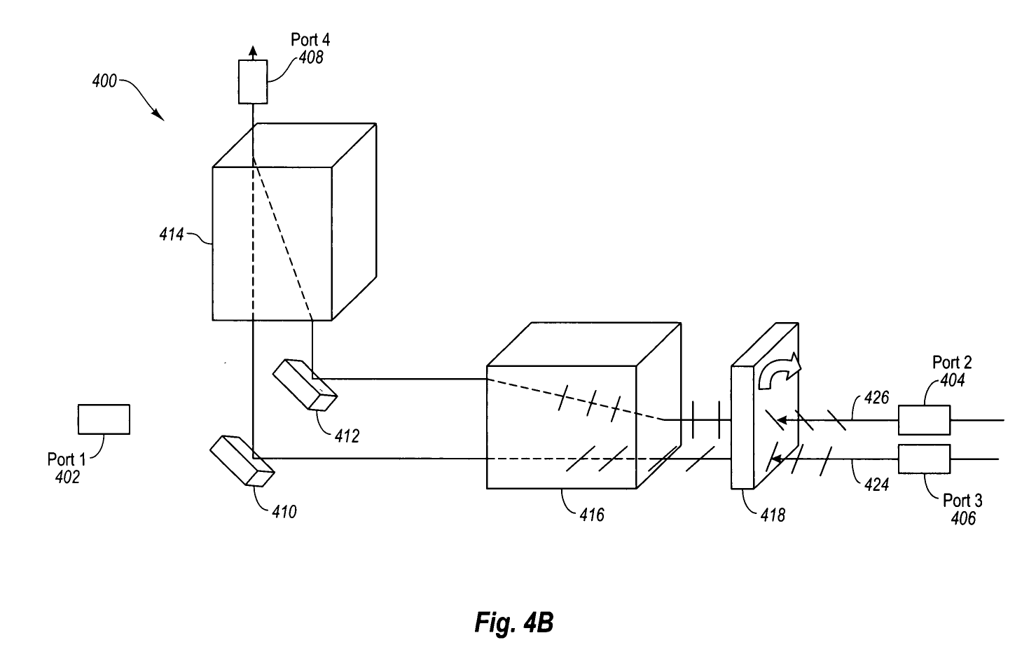

An alternative configuration of a low insertion loss circulator 400 is shown in FIG. 4, where the PDCE is a beam displacer. Like the circulators outlined above, circulator 400 includes four ports: ports 402, 404, 406, and 408. Reflectors 410 and 412 are arranged for optical communication with port 402, and beam displacer 414 is arranged for optical communication with port 408. Beam displacer 416 is arranged for optical communication with reflectors 410 and 412, and with Faraday rotator 418, the Faraday rotator 418 being arranged for optical communication with ports 404 and 406.

FIG. 4 shows the transmission path of light that enters circulator 400 through port 402. When the light enters circulator 400 at port 402, the light may be polarized or unpolarized, or have any combination of polarization states. In the exemplary embodiment shown in FIG. 4, the light entering circulator 400 through port 402 is unpolarized. The light then passes between reflectors 410 and 412, without experiencing any deflection, and enters beam displacer 416 where the light is separated into two separate, orthogonally polarized beams.

As shown in FIG. 4, a first beam 420 passes through the beam displacer 416 without being deflected. A second beam 422, however, which has a polarization orthogonal to the polarization of the first beam 420, is deflected away from first beam 420 within beam displacer 416, and onto a separate path. Each of the now separated first and second beams 420 and 422 passes through Faraday rotator 418, which rotates the polarization angles of each of first beam 420 and second beam 422 by 45 degrees. Upon exiting Faraday rotator 418, first beam 420 is transmitted from circulator 400 through port 404. Second beam 422, which has a polarization orthogonal to the polarization of first beam 420, is transmitted from circulator 400 through port 406.

With attention now to FIG. 4B, details are provided concerning the reception path of light received into circulator 400 through ports 404 and 406. In the exemplary embodiment shown in FIG. 4B, the beam of light 424 entering circulator 400 through port 406 has a polarization state identical to the polarization state of beam 422 transmitted from port 406 in FIG. 4A. After entering circulator 400 through port 406, beam 424 passes through Faraday rotator 418, which rotates the polarization angle of beam 424 by 45 degrees. Upon entering beam displacer 416, beam 424 has a polarization state orthogonal to the polarization state of beam 422 when beam 422 exits beam displacer 416 in FIG. 4A. Unlike beam 422 of FIG. 4A which is deflected by beam displacer 416, beam 424 is not deflected by beam displacer 416. After exiting beam displacer 416, beam 424 is directed toward reflector 410 where beam 424 is reflected toward beam displacer 414. Beam 424 travels through beam displacer 414 before exiting circulator 400 through port 408.

Like beam 424 which enters circulator 400 through port 406, beam 426, which enters circulator 400 through port 404, also exits circulator 400 through port 408. However, the path traveled by beam 426 through circulator 400 differs from the path traveled by beam 424 through circulator 400.

Particularly, in the embodiment shown in FIG. 4B, the beam of light 426 entering port 404 has a polarization state identical to the polarization state of the beam of light 420 exiting port 404 in FIG. 4A. The beam 426 passes through Faraday rotator 418, where the polarization angle of the beam 426 is rotated by 45 degrees, and the beam 426 then passes through beam displacer 416. As beam 426 passes through beam displacer 416, beam 426 is deflected, and, due to the deflection, after exiting beam displacer 416 beam 426 is directed toward reflector 412. Reflector 412 further directs beam 426 toward beam displacer 414. Upon entering beam displacer 414, beam 426 is deflected such that the path traveled by beam 426 intersects the path traveled by beam 424, and beam 426 combines with beam 424 in the beam displacer 414. Thus, beams 424 and 426 exit beam displacer 414 and enter port 408 as a single, combined beam of light. In the embodiment of the invention shown in FIG. 4B, no light enters or exits circulator 400 through port 402.

A circulator configured as outlined above includes relatively few optical components and provides a low insertion loss when integrated with other optoelectronic components or systems. In addition, the above-described circulator is characterized by a compact size, integrated functionality, and high performance, thus allowing the realization of high-performance, efficient, and low cost optical devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical circulator, comprising:
first, second, third and fourth ports;
a PDCE arranged for optical communication with the first and fourth ports, the polarization dividing and combining element being configured such that for an input beam to the PDCE, a corresponding output of the PDCE comprises a pair of beams whose respective polarizations are orthogonal to each other, and the PDCE further configured such that for an input to the PDCE of a pair of beams of orthogonal respective polarizations, a corresponding output of the PDCE comprises a single beam of light;
a first Faraday rotator arranged for optical communication with the second port and with the PDCE; and
a second Faraday rotator arranged for optical communication with the third port and with the PDCE.

2. The optical circulator as recited in claim 1, wherein the first and second Faraday rotators are each configured so that an output beam of light is rotated 45 degrees relative to an input beam of light.

3. The optical circulator as recited in claim 1, wherein the first and second Faraday rotators are nonreciprocal.

4. The optical circulator as recited in claim 1, wherein the first and second Faraday rotators are comprised of one of: glass; or magneto-optical materials.

5. The optical circulator as recited in claim 1, wherein the first and second Faraday rotators are one of: latching; or, non-latching.

6. The optical circulator as recited in claim 1, further comprising magnets configured to apply a magnetic field to the first and second Faraday rotators.

7. The optical circulator as recited in claim 1, wherein the PDCE comprises a polarization beam splitter.

8. The optical circulator as recited in claim 1, wherein the PDCE comprises one of: calcite; YVO4; Rutile; or, LiNbO₃.

9. The optical circulator as recited in claim 1, wherein the PDCE comprises a pair of one of: Wollaston prisms; Nicol prisms; Rochon prisms; Glen-Thompson prisms; Glen-Taylor prisms; or, Right Angle Prisms with thin-film coatings.

10. An optical circulator, comprising:
first, second, third and fourth ports;
a first beam displacer in optical communication with the first port;
a Faraday rotator positioned between the first beam displacer and the second and third ports;
a second beam displacer in optical communication with the fourth port;
a first reflector arranged so that an optical signal received at the first reflector from the first beam displacer is redirected to the second beam displacer; and
a second reflector arranged so that an optical signal received at the second reflector from the first beam displacer is redirected to the second beam displacer.

11. The optical circulator as recited in claim 10, wherein an input beam of light to the optical circulator at the first port corresponds to an output of the optical circulator, at the second and third ports, of respective first and second beams of light, the first beam of light having a polarization that is different than a polarization of the second beam of light.

12. The optical circulator as recited in claim 11, wherein the input beam has one of the following characteristics: the input beam is polarized; the input beam is unpolarized; or, the input beam has a combination of polarization states.

13. The optical circulator as recited in claim 10, wherein an input beam of light to the optical circulator of first and second beams of light at the second and third ports, respectively, corresponds to an output of the optical circulator, at the fourth port, of a single beam of light.

14. The optical circulator as recited in claim 13, wherein the first and second beams of light are polarized.

15. The optical circulator as recited in claim 10, wherein the Faraday rotator is nonreciprocal.

16. The optical circulator as recited in claim 10, wherein the Faraday rotator is configured so that an output beam of light is rotated 45 degrees relative to an input beam of light.

17. The optical circulator as recited in claim 10, wherein the Faraday rotator comprises one of: glass; or magneto-optical materials.

18. The optical circulator as recited in claim 10, wherein the Faraday rotator is one of: latching; or, non-latching.

19. The optical circulator as recited in claim 10, further comprising magnets configured to apply a magnetic field to the Faraday rotator.

20. The optical circulator as recited in claim 10, wherein the optical circulator is configured so that an input light beam received at the first port bypasses the second beam displacer.
